(19) United States
(12) Patent Application Publication
(10) Pub. No.: US 2025/0109317 A1
(43) Pub. Date: Apr. 3, 2025

(54) POLISHING COMPOSITION

(71) Applicant: FUJIMI INCORPORATED, Kiyosu-shi (JP)

(72) Inventors: Yasuyuki YAMATO, Kiyosu-shi (JP); Shota SUZUKI, Kiyosu-shi (JP)

(73) Assignee: FUJIMI INCORPORATED, Kiyosu-shi (JP)

(21) Appl. No.: 18/783,714

(22) Filed: Jul. 25, 2024

(30) Foreign Application Priority Data
Sep. 28, 2023 (JP) 2023-166812

(51) Int. Cl. C09G 1/02

(52) U.S. Cl. CPC C09G 1/02

(57) ABSTRACT

An object of the present invention is to provide a novel polishing composition capable of reducing remaining of an object to be polished, which has to be polished, such as polysilicon, and suppressing recesses. There is provided a polishing composition containing colloidal silica, an alkali metal salt, and water, a pH of the polishing composition being 9.0 to 11.5, wherein (i) in an object to be polished including a first layer provided with a recess portion and a second layer formed to fill the inside of the recess portion, the polishing composition is used for a step of polishing the second layer to expose the first layer, the first layer is selected from a layer having an oxygen-silicon bond and a layer having a nitrogen-silicon bond, and the second layer has a silicon-silicon bond, and/or (ii) the number of silanol groups in the colloidal silica is 6/nm² or more and 22/nm² or less.

### CROSS-REFERENCE TO RELATED APPLICATION

The present application is based on Japanese Patent Application No. 2023-166812 filed on Sep. 28, 2023, the disclosure content of which is incorporated herein by reference in its entirety.

### BACKGROUND

### 1. Technical Field

The present invention relates to a polishing composition.

### 2. Description of Related Arts

In the CMP field, a silicon dioxide film provided with a recess portion and a polysilicon film formed so as to fill the inside of the recess portion may be disposed, and polishing may be performed using the silicon dioxide film as a stopper layer.

As an index indicating how easily the polysilicon film is polished with respect to the silicon dioxide film, a selectivity that is a ratio of a rate at which the polysilicon film is polished to a rate at which the silicon dioxide film is polished is used. The selectivity is determined by dividing the rate at which the polysilicon film is polished by that of the silicon dioxide film. In order for the silicon dioxide film to function as a stopper layer, it is preferable that the selectivity is large.

JP H10-321569 A aims at providing a polishing composition which can obtain a high selectivity and causes less surface defects. JP H10-321569 A provides a polishing composition containing an abrasive such as silicon dioxide and water, which may further contain a basic organic compound such as tetramethylammonium hydroxide.

### SUMMARY

In the course of developing a new polishing composition, the present inventors have found that a so-called recess may occur in which polysilicon buried in a recess portion formed ina silicon dioxide film is also excessively polished in a conventional technique. In the course of further studies, the present inventors have found that even when the selectivity is controlled, if abrasive grains are not appropriate or the pH of the polishing composition is not appropriate, polysilicon remains or recesses occur after polishing.

Therefore, an object of the present invention is to provide a novel polishing composition capable of reducing remaining of an object to be polished, which has to be polished, such as polysilicon, and suppressing recesses.

One aspect of the present invention is a polishing composition containing colloidal silica, an alkali metal salt, and water, a pH of the polishing composition being 9.0 to 11.5, wherein (i) in an object to be polished including a first layer provided with a recess portion and a second layer formed to fill the inside of the recess portion, the polishing composition is used for a step of polishing the second layer to expose the first layer, the first layer is selected from a layer having an oxygen-silicon bond and a layer having a nitrogen-silicon bond, and the second layer has a silicon-silicon bond, and/or (ii) the number of silanol groups in the colloidal silica is 6/nm² or more and 22/nm² or less.

According to the present invention, it is possible to provide a novel polishing composition capable of reducing remaining of an object to be polished, which has to be polished, such as polysilicon, and suppressing recesses.

### BRIEF DESCRIPTION OF THE DRAWINGS

FIG. 1 is a schematic cross-sectional view of an object to be polished before polishing;

FIG. 2 is a schematic cross-sectional view of a polished object after being ideally polished;

FIG. 3 is a schematic cross-sectional view of a polished object which is not ideally polished and in which recesses occur as defects;

FIG. 4 is a schematic cross-sectional view of a polished object which is not ideally polished and in which an object to be polished, which has to be polished, remains as a defect; and

FIG. 5 is a schematic cross-sectional view of a polished object in which defects in FIGS. 3 and 4 occur simultaneously.

### DETAILED DESCRIPTION

Hereinafter, the present invention will be described in detail. In the present specification, “X to Y” is used to mean that the first and last numerical values (X and Y) are included as a lower limit value and an upper limit value, and means “X or more and Y or less”. When a plurality of “X to Y” are described, for example, when “X1 to Y1, or X2 to Y2” is described, the disclosure of each numerical value as the upper limits, the disclosure of each numerical value as the lower limits, and the disclosure of the combination of those upper and lower limits are all included (that is, the lawful basis for the amendment). Specifically, the amendment to X1 or more, amendment to Y2 or less, amendment to X1 or less, amendment to Y2 or more, amendment to X1 to X2, amendment to X1 to Y2, or the like should all be considered legal. Where features or aspects of the present disclosure are described in terms of Markush groups, those skilled in the art will recognize that the present disclosure is thereby described in terms of any individual member of the Markush group or subgroup of members of the Markush group. Unless otherwise specified, operations and measurements of physical properties and the like are measured under the conditions of room temperature (20 to 25° C.)/relative humidity of 40 to 50% RH. The concentration described in the present specification may be a concentration at POU (point of use) or a concentration before dilution to the POU concentration. The dilution ratio may be 2 to 10 times. It should also be understood that all embodiments and combinations of descriptions disclosed in the present specification are disclosed in this application. That is, it should be understood that it can be a basis for the amendment. When the content or concentration of each component is described, it can be the total amount when two or more kinds thereof are included.

### <Polishing Composition>

One aspect of the present invention is a polishing composition containing colloidal silica, an alkali metal salt, and water, a pH of the polishing composition being 9.0 to 11.5, wherein (i) in an object to be polished including a first layer provided with a recess portion and a second layer formed to fill the inside of the recess portion, the polishing composition is used for a step of polishing the second layer to expose the first layer, the first layer is selected from a layer having an oxygen-silicon bond and a layer having a nitrogen-silicon bond, and the second layer has a silicon-silicon bond, and/or (ii) the number of silanol groups in the colloidal silica is 6/nm² or more and 22/nm² or less. According to this aspect, it is possible to provide a novel polishing composition capable of reducing remaining of an object to be polished, which has to be polished, such as polysilicon, and suppressing recesses. The mechanism by which such a technical effect appears is considered as follows. In a region where the pH is alkaline, hydroxide ions (OH⁻) become rich in the polishing composition, and the surface of the object to be polished having a silicon-silicon bond such as polysilicon changes to a silanol group (SiOH). At the time of polishing, a reaction between the object to be polished having changed to a silanol group (SiOH) and the colloidal silica having the number of silanol groups in the above range is promoted by hydrogen bonding, and remaining on a pattern wafer is reduced. It is presumed that the use of the alkali metal salt suppresses excessive etching of the object to be polished having a silicon-silicon bond, and as a result, is effective for suppressing recesses. However, such a mechanism goes beyond speculation, and the technical scope of the present invention is not limited by such a mechanism.

In an embodiment of the present invention, a step of further polishing the first layer after the first layer is exposed is included. By further including such a step, a technical effect of completely removing remaining of an object to be polished, which has to be polished, such as polysilicon, is achieved.

### [Abrasive Grains]

The polishing composition of an aspect of the present invention contains colloidal silica as abrasive grains. The abrasive grains have a function of mechanically polishing an object to be polished. The colloidal silica can be produced by a sol-gel method. For example, the colloidal silica can be obtained by performing a hydrolysis/condensation reaction using a hydrolyzable silicon compound (for example, alkoxysilane or a derivative thereof) as a raw material.

According to an embodiment of the present invention, the number of silanol groups in the colloidal silica is 6/nm² or more and 22/nm² or less. When the number of silanol groups in the colloidal silica is less than 6/nm² or more than 22/nm², there is a possibility that remaining of an object to be polished, which has to be polished, such as polysilicon, increases or recesses are promoted. Examples of the method of controlling the number of silanol groups in the colloidal silica to 6/nm² or more and 22/nm² or less include a hydrothermal treatment of a dispersion containing colloidal silica. As conditions of the hydrothermal treatment, the dispersion containing colloidal silica is heat-treated at a temperature of, for example, 100° C. to 200° C. for 30 to 60 minutes.

According to an embodiment of the present invention, the number of silanol groups in the colloidal silica is 6.1/nm² or more, 6.2/nm² or more, 6.3/nm² or more, 6.4/nm² or more, 6.5/nm² or more, 6.6/nm² or more, more than 6.6/nm², 6.7/nm² or more, 6.8/nm² or more, 6.9/nm or more, 7.0/nm² or more, 7.1/nm² or more, 7.2/nm² or more, 7.3/nm² or more, 7.4/nm² or more, 7.5/nm² or more, 7.6/nm² or more, 7.7/nm² or more, 7.8/nm² or more, 9/nm² or more, 10/nm² or more, 12/nm² or more, 14/nm² or more, or 16/nm² or more.

According to an embodiment of the present invention, the number of silanol groups in the colloidal silica is 21/nm² or less, 20/nm² or less, 19/nm² or less, 18/nm² or less, less than 17.5/nm², 17/nm² or less, 16/nm² or less, 15/nm² or less, 14/nm² or less, 13/nm² or less, 12/nm² or less, 11/nm² or less, 10/nm² or less, 9/nm² or less, 8/nm² or less, or 7/nm² or less. The method of measuring the number of silanol groups is the method described in EXAMPLES.

According to an embodiment of the present invention, a pulsed NMR specific surface area of the colloidal silica is 40 m²/g or less. According to an embodiment of the present invention, the pulsed NMR specific surface area of the colloidal silica is 39 m²/g or less, 38 m²/g or less, 37 m²/g or less, 36 m/g or less, 35 m²/g or less, 34 m²/g or less, 33 m²/g or less, 32 m²/g or less, 31 m²/g or less, 30 m²/g or less, 29 m²/g or less, 28 m²/g or less, 27 m²/g or less, 26 m²/g or less, 25 m²/g or less, or 24 m²/g or less. According to an embodiment of the present invention, the pulsed NMR specific surface area of the colloidal silica is 10 m²/g or more, 15 m²/g or more, or 20 m²/g or more. The method of measuring the pulsed NMR specific surface area of the abrasive grains (particularly colloidal silica) is the method described in EXAMPLES. The pulsed NMR specific surface area of the colloidal silica can be controlled by increasing or decreasing the number of protons of the colloidal silica surface functional group since an aspect in which the relaxation rate of proton resonance changes depending on the amount of molecules adsorbed on the solid surface or the like is measured.

According to an embodiment of the present invention, the lower limit of the average primary particle size of the abrasive grains (particularly, colloidal silica) is 60 nm or more, 70 nm or more, more than 70 nm, 71 nm or more, 72 nm or more, 73 nm or more, 74 nm or more, 75 nm or more, 76 nm or more, 77 nm or more, 78 nm or more, 79 nm or more, 80 nm or more, 81 nm or more, 82 nm or more, 83 nm or more, 84 nm or more, 85 nm or more, 86 nm or more, 87 nm or more, 88 nm or more, 89 nm or more, or 95 nm or more.

According to an embodiment of the present invention, the upper limit of the average primary particle size of the abrasive grains (particularly, colloidal silica) is 110 nm or less, less than 100 nm, 99 nm or less, 98 nm or less, 97 nm or less, 96 nm or less, 95 nm or less, 94 nm or less, 93 nm or less, 92 nm or less, or 91 nm or less. According to an embodiment of the present invention, the average primary particle size of the colloidal silica is more than 70 nm and less than 100 nm. The method of measuring the average primary particle size is the method described in EXAMPLES.

According to an embodiment of the present invention, the lower limit of the average secondary particle size of the abrasive grains (particularly, colloidal silica) is 110 nm or more, 120 nm or more, 130 nm or more, 140 nm or more, 150 nm or more, 160 nm or more, 170 nm or more, 180 nm or more, 190 nm or more, 200 nm or more, 210 nm or more, or 215 nm or more.

According to an embodiment of the present invention, the upper limit of the average secondary particle size of the abrasive grains (particularly, colloidal silica) is 350 nm or less, 340 nm or less, 330 nm or less, 320 nm or less, 310 nm or less, 300 nm or less, 290 nm or less, 280 nm or less, 270 nm or less, 260 nm or less, 250 nm or less, 240 nm or less, 230 nm or less, or 225 nm or less. The method of measuring the average secondary particle size is the method described in EXAMPLES.

According to an embodiment of the present invention, the average association degree (average secondary particle size/average primary particle size) of the abrasive grains (particularly, colloidal silica) is 1.6 or more, 1.7 or more, 1.8 or more, 1.9 or more, 2.0 or more, 2.1 or more, 2.2 or more, 2.3 or more, or 2.4 or more.

According to an embodiment of the present invention, the average association degree (average secondary particle size/average primary particle size) of the abrasive grains (particularly, colloidal silica) is 4.6 or less, 4.4 or less, 4.2 or less, 4.0 or less, 3.8 or less, 3.6 or less, 3.4 or less, 3.2 or less, 3.0 or less, 2.9 or less, 2.8 or less, 2.7 or less, 2.6 or less, or 2.5 or less.

According to an embodiment of the present invention, the content ratio of the abrasive grains (particularly, colloidal silica) in the polishing composition is 0.01 mass % or more, 0.05 mass % or more, 0.1 mass % or more, 0.5 mass % or more, 0.6 mass % or more, 0.7 mass % or more, 0.8 mass % or more, 0.9 mass % or more, 1.0 mass % or more, 1.1 mass % or more, 1.2 mass % or more, 1.3 mass % or more, or 1.4 mass % or more.

According to an embodiment of the present invention, the content ratio of the abrasive grains (particularly, colloidal silica) in the polishing composition is 10 mass % or less, 5 mass % or less, 3 mass % or less, or 2 mass % or less.

According to an embodiment of the present invention, the amount of the colloidal silica in the abrasive grains contained in the polishing composition is 90 mass % or more, 95 mass % or more, 98 mass % or more, 99 mass % or more, 99.5 mass % or more, or 99.9 mass % or more (the upper limit is 100 mass %).

According to an embodiment of the present invention, the surface of the abrasive grains (particularly, colloidal silica) contained in the polishing composition is not subjected to a treatment for chemically bonding a treatment agent such as an organic acid (for example, sulfonic acid or carboxylic acid).

### (Alkali Metal Salt)

The polishing composition of an aspect of the present invention contains an alkali metal salt. When the polishing composition does not contain an alkali metal salt, there is a possibility that remaining of an object to be polished, which has to be polished, such as polysilicon, cannot be reduced or recesses are promoted.

According to an embodiment of the present invention, at least one selected from the group consisting of an alkali metal hydroxide and an alkali metal carbonate is contained as the alkali metal salt. According to an embodiment of the present invention, an alkali metal hydroxide is contained as the alkali metal salt. From the viewpoint of reducing recesses and reducing the remaining metal, as the alkali metal salt, an alkali metal hydroxide is more preferable than an alkali metal carbonate. According to an embodiment of the present invention, potassium hydroxide is contained as an alkali metal hydroxide. Examples of the alkali metal include potassium, sodium, lithium, and the like, and among these, from the viewpoint of reducing the remaining metal, potassium is particularly preferable.

The alkali metal salt also has a function as a pH adjusting agent for adjusting the pH of the polishing composition. According to an embodiment of the present invention, the content of the pH adjusting agent (particularly, the alkali metal salt) contained in the polishing composition is an amount appropriate for adjusting the pH of the polishing composition to a predetermined pH (particularly, the pH is 9.0 to 11.5).

According to an embodiment of the present invention, the amount of the alkali metal salt (particularly, potassium hydroxide) in the pH adjusting agent contained in the polishing composition is 90 mass % or more, 95 mass % or more, 98 mass % or more, 99 mass % or more, 99.5 mass % or more, or 99.9 mass % or more (the upper limit is 100 mass %). According to an embodiment of the present invention, the amount of potassium hydroxide in the pH adjusting agent contained in the polishing composition is 90 mass % or more, 95 mass % or more, 98 mass % or more, 99 mass % or more, 99.5 mass % or more, or 99.9 mass % or more (the upper limit is 100 mass %). Even when the abrasive grains (particularly, colloidal silica) and an antiseptic agent which can be optionally contained have a function of slightly changing the pH of the polishing composition, the ability to change the pH is low, and thus, in the present invention, such a component (such components) is not included in the category of the pH adjusting agent.

[pH]

The pH of the polishing composition of an aspect of the present invention is 9.0 to 11.5. When the pH of the polishing composition is less than 9.0 or more than 11.5, there is a possibility that remaining of an object to be polished, which has to be polished, such as polysilicon, cannot be reduced or recesses are promoted.

According to an embodiment of the present invention, the pH of the polishing composition is 9.1 or more, 9.2 or more, 9.3 or more, 9.4 or more, 9.5 or more, more than 9.5, 9.6 or more, 9.7 or more, 9.8 or more, 9.9 or more, or 10.5 or more. According to an embodiment of the present invention, the pH of the polishing composition is 11.5 or less, 11.4 or less, 11.3 or less, 11.2 or less, 11.1 or less, 11 or less, less than 11, 10.9 or less, 10.8 or less, 10.7 or less, 10.6 or less, 10.5 or less, 10.4 or less, 10.3 or less, 10.2 or less, 10.1 or less, or 9.8 or less.

According to an embodiment of the present invention, the pH of the polishing composition is not 9.1, 9.2, 9.3, 9.4, 9.6, 9.7, 9.8, 9.9, 10.1, 10.2, 10.3, 10.4, 10.5, 10.6, 10.7, 10.8, 10.9, 11.1, 11.2, 11.3, 11.4, or 11.5. The method of measuring the pH of the polishing composition is the method described in EXAMPLES.

### [Object to be Polished]

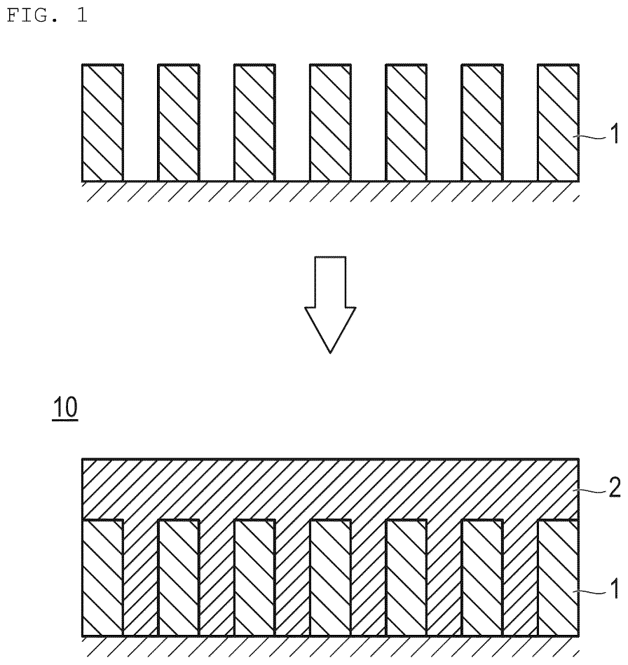

According to an embodiment of the present invention, the polishing composition is used in a step of polishing a second layer to expose a first layer in an object to be polished including a first layer provided with a recess portion and a second layer formed to fill the inside of the recess portion. FIG. 1 is a schematic cross-sectional view of an object to be polished (before polishing). As illustrated in the upper view of FIG. 1, a first layer 1 (a film having an oxygen-silicon bond or a nitrogen-silicon bond) is formed on an arbitrary film (for example, a Si substrate) so as to provide a recess portion. As illustrated in the lower view of FIG. 1, a second layer 2 (a film having a silicon-silicon bond) is formed so as to fill the inside of the recess portion, thereby forming an object to be polished 10 including the first layer and the second layer.

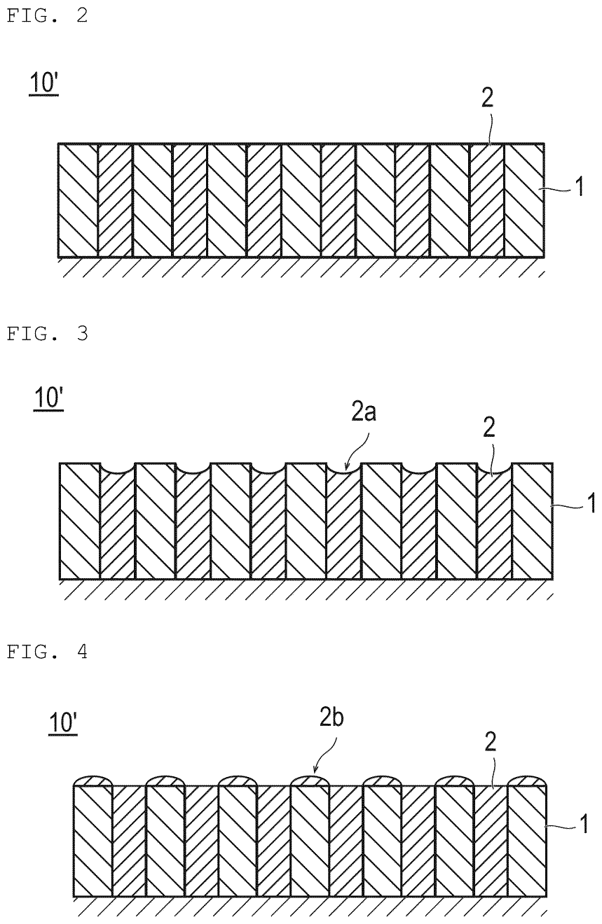

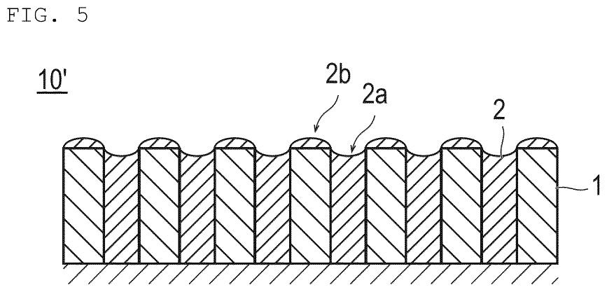

When the polishing composition of the present invention is applied to such an object to be polished 10, as illustrated in FIG. 2, a polished object 10′, which is the object to be polished after polishing, has an ideal polished surface in which remaining of the object to be polished (a film having a silicon-silicon bond), which has to be polished, reduced (no remaining) and recesses are also suppressed (not generated). By applying the polishing composition of the present invention, the number of metal atoms that may remain after polishing can also be reduced. According to an embodiment of the present invention, the number of metal atoms remaining per 1 cm² of the polished object (unit: ×10¹⁰/cm²) is 40 or less, less than 38, less than 35, 30 or less, 25 or less, 20 or less, or less than 19. According to an embodiment of the present invention, the number of metal atoms remaining per 1 cm² of the polished object (unit: ×10¹⁰/cm²) is, for example, 0, 0.01 or more, 0.5 or more, 1 or more, 5 or more, or 10 or more. When the object to be polished 10 including the first layer and the second layer is polished with a polishing composition (that is, polishing composition of comparative example) other than the polishing composition of the present invention, for example, recesses 2a are generated as illustrated in FIG. 3, remaining 2b of the object to be polished (a film having a silicon-silicon bond), which has to be polished, is generated as illustrated in FIG. 4, or these are simultaneously generated as illustrated in FIG. 5.

In an embodiment of the present invention, examples of the object to be polished having an oxygen-silicon bond include a TEOS type silicon oxide (hereinafter, also simply referred to as “TEOS”) produced using tetraethyl orthosilicate as a precursor, HDP (High Density Plasma), USG (Undoped Silicate Glass), PSG (Phosphorus Silicate Glass), BPSG (Boron-Phospho Silicate Glass), RTO (Rapid Thermal Oxidation), and the like. A TEOS film can be formed by plasma CVD.

In an embodiment of the present invention, examples of the object to be polished having a nitrogen-silicon bond include a silicon nitride film, SiCN (silicon carbonitride), and the like. Among them, the first layer is preferably a silicon oxide film (TEOS film) from tetraethyl orthosilicate. In an embodiment of the present invention, examples of the object to be polished having a silicon-silicon bond include polysilicon, amorphous silicon, monocrystalline silicon, n-type doped monocrystalline silicon, p-type doped monocrystalline silicon, Si-based alloys such as SiGe, and the like. Among them, the second layer is preferably polycrystalline silicon such as polysilicon.

### [Polishing Removal Rate]

According to an embodiment of the present invention, the polishing composition has a physical property in which the polishing removal rate of the second layer is 2000 Å/min or more, 2200 Å/min or more, 2400 Å/min or more, 2600 Å/min or more, 2800 Å/min or more, or 3000 Å/min or more. According to an embodiment of the present invention, the polishing composition has a physical property in which the polishing removal rate of the second layer is 3500 Å/min or less or 3200 Å/min or less.

According to an embodiment of the present invention, the polishing composition has a physical property in which the polishing removal rate of the first layer is 60 Å/min or more, 70 Å/min or more, 80 Å/min or more, or 90 Å/min or more. According to an embodiment of the present invention, the polishing composition has a physical property in which the polishing removal rate of the first layer is 180 Å/min or less, 160 Å/min or less, 140 Å/min or less, 120 Å/min or less, 100 Å/min or less, or 95 Å/min or less.

### [Selectivity]

According to an embodiment of the present invention, the polishing composition has a physical property in which the polishing removal rate of the second layer with respect to the polishing removal rate of the first layer (selectivity) is 17 to 40 or 20 to 40. When the selectivity is less than 17 or more than 40, there is a possibility that remaining of an object to be polished, which has to be polished, such as polysilicon, cannot be reduced or recesses are promoted.

According to an embodiment of the present invention, the polishing composition has a physical property in which the selectivity is 17 or more, 18 or more, 19 or more, 20 or more, 21 or more, 22 or more, 23 or more, 24 or more, 25 or more, 26 or more, 27 or more, 28 or more, 29 or more, 30 or more, 31 or more, 32 or more, 33 or more, 34 or more, or 35 or more.

According to an embodiment of the present invention, the polishing composition has a physical property in which the selectivity is 39 or less, 37 or less, 35 or less, 33 or less, 31 or less, or 29 or less.

### [Transmittance]

According to an embodiment of the present invention, a transmittance when light whose wavelength is 450 nm is transmitted through the polishing composition is more than 0.1% and less than 1% in a case where a concentration of the abrasive grains (particularly, colloidal silica) contained in the polishing composition is 1.5 mass %. According to such an embodiment, the mechanical action on an object to be polished, which has to be polished, such as polysilicon, is improved, which is effective in reducing remaining thereof on the pattern wafer. Examples of the method of adjusting the transmittance to the above range include a method of adjusting the particle size of the colloidal silica and a method of adjusting an electrical conductivity.

According to an embodiment of the present invention, the transmittance is 0.13% or more or 0.5% or more. According to an embodiment of the present invention, the transmittance is 0.9% or less, 0.7% or less, 0.5% or less, or 0.3% or less.

When the abrasive grain concentration of the polishing composition is not 1.5 mass %, the adjustment of the abrasive grain concentration to 1.5 mass % can be performed as follows. That is, when the abrasive grain concentration of the polishing composition is more than 1.5 mass %, an appropriate amount of water can be added so that the abrasive grain concentration becomes 1.5 mass %. When the abrasive grain concentration of the polishing composition is less than 1.5 mass %, the polishing composition may be stored in an environment of 25 to 40° C. until the abrasive grain concentration becomes 1.5 mass %, or a treatment such as ultrafiltration may be performed.

### [Water]

The polishing composition of an aspect of the present invention contains water as an aqueous carrier. According to an embodiment of the present invention, the aqueous carrier is not limited that the aqueous carrier necessarily includes alcohols such as methanol, ethanol, and ethylene glycol; ketones such as acetone; and the like, and the amount of water in the aqueous carrier is 90 mass % or more, 95 mass % or more, 98 mass % or more, 99 mass % or more, 99.5 mass % or more, or 99.9 mass % or more (the upper limit is 100 mass %).

### [Antiseptic Agent]

According to an embodiment of the present invention, the polishing composition contains an antiseptic agent. Examples of the antiseptic agent include isothiazoline-based antiseptic agents such as 2-methyl-4-isothiazoline-3-one and 5-chloro-2-methyl-4-isothiazoline-3-one, paraoxybenzoic acid ester-based antiseptic agents such as methyl paraoxybenzoate (methyl parahydroxybenzonate) and ethyl paraoxybenzoate (ethyl parahydroxybenzonate), phenoxyethanol, and the like. These antiseptic agents may be used singly or in combination of two or more kinds thereof.

According to an embodiment of the present invention, the antiseptic agent may be contained in the polishing composition in an amount of 0.001 to 1 mass %, 0.005 to 0.5 mass %, or 0.01 to 0.1 mass %.

According to an embodiment of the present invention, there is provided a polishing composition consisting essentially of colloidal silica having the number of silanol groups of 6/nm² or more and 22/nm² or less, an alkali metal salt, an antiseptic agent, and water, a pH of the polishing composition being 9.0 to 11.5.

### [Other Components]

The polishing composition of the present invention preferably has a simple configuration, that is, it is preferable that a component other than colloidal silica, an alkali metal salt (particularly, potassium hydroxide), water, and an antiseptic agent, which is optionally contained, is not contained as much as possible. When the polishing composition contains a component (components) other than colloidal silica, an alkali metal salt (particularly, potassium hydroxide), water, and an antiseptic agent, which is optionally contained, the ratio of the component (the total ratio of these components) is preferably 0.1 mass % or less, 0.01 mass % or less, 0.001 mass % or less, or less than 0.0001 mass % in the polishing composition. In the polishing composition, the fact that the concentration of one or more components (in the case of two or more components, the total concentration thereof) other than colloidal silica, an alkali metal salt (particularly, potassium hydroxide), water, and an antiseptic agent, which is optionally contained, is 0.1 mass % or less, 0.01 mass % or less, 0.001 mass % or less, or less than 0.0001 mass % is also referred to as “substantially free of” the component (these components).

According to an embodiment of the present invention, the polishing composition is substantially free of at least one selected from the group consisting of hydroxyethyl cellulose (HEC), polyacrylic acid (PAA), polyoxyethylene (POE) lauryl ether, dodecylbenzene sulfonic acid (DBS), hydrogen peroxide (H₂O₂), ammonia (ammonium ion), and amine. Describing “substantially free of at least one selected from the group consisting of” with reference to several cases, this includes, for example, a case where the polishing composition is substantially free of hydroxyethyl cellulose (HEC) (that is, it means that the polishing composition does not contain hydroxyethyl cellulose (HEC) at all (detection limit or less) or contains 0.1 mass % or less, 0.01 mass % or less, 0.001 mass or less, or less than 0.0001 mass % of hydroxyethyl cellulose if the polishing composition contains hydroxyethyl cellulose), a case where the polishing composition is substantially free of hydroxyethyl cellulose (HEC) and polyacrylic acid (PAA) (that is, it means that the polishing composition does not contain either hydroxyethyl cellulose (HEC) or polyacrylic acid (PAA) at all (detection limit or less) or contains 0.1 mass % or less, 0.01 mass % or less, 0.001 mass % or less, or less than 0.0001 mass % of these components in total if the polishing composition contains these components), and the like. The concept of “substantially free of at least one selected from the group consisting of” in the present specification is to be understood as such by those substantially in the art.

According to an embodiment of the present invention, the polishing composition is substantially free of polyoxyalkylene alkyl ether. According to an embodiment of the present invention, the polishing composition is substantially free of alkylarylsulfonic acid.

According to an embodiment of the present invention, the polishing composition is substantially free of at least one selected from the group consisting of a water-soluble polymer, a surfactant, an oxidizing agent, and a compound having a nitrogen atom. According to an embodiment of the present invention, the content (mass %) of the surfactant in the polishing composition is less than 0.001 mass %, 0.0005 mass % or less, 0.0001 mass % or less, or the detection limit or less.

According to an embodiment of the present invention, the water-soluble polymer refers to a water-soluble polymer in which, when the water-soluble polymer is dissolved in water with a concentration of 0.5 mass % at a temperature at which the water-soluble polymer can be dissolved by the possible largest quantity, the mass of insoluble matter separated by filtration in the case of filtration with a G2 glass filter (maximum pore size: 40 to 50 μm) is 50 mass % or less of the water-soluble polymer added. According to an embodiment of the present invention, the term “water-soluble” means that the solubility in water (25° C.) is 1 g/100 mL or more, and the term “polymer” refers to a (co) polymer having a repeating unit in its molecular structure and a weight average molecular weight (Mw) of 1,000 or more. According to an embodiment of the present invention, examples of the water-soluble polymer include nonionic water-soluble polymers such as polyvinyl alcohol (PVA), polyvinyl pyrrolidone (PVP), pullulan, and hydroxyethyl cellulose; anionic water-soluble polymers such as polyacrylic acid and carboxymethyl cellulose; cationic water-soluble polymers such as polyacrylamide, and the like. According to an embodiment of the present invention, the polishing composition is substantially free of at least one kind selected from the group consisting of these. Describing “substantially free of at least one kind selected from the group consisting of these” with reference to several cases, this includes, for example, a case where the polishing composition is substantially free of a nonionic water-soluble polymer (that is, it means that the polishing composition does not contain a nonionic water-soluble polymer at all (detection limit or less) or contains 0.1 mass % or less, 0.01 mass % or less, 0.001 mass % or less, or less than 0.0001 mass % of the nonionic water-soluble polymer if the polishing composition contains the nonionic water-soluble polymer), a case where the polishing composition is substantially free of a nonionic water-soluble polymer and a cationic water-soluble polymer (that is, it means that the polishing composition does not contain either a nonionic water-soluble polymer or a cationic water-soluble polymer at all (detection limit or less) or contains 0.1 mass % or less, 0.01 mass % or less, 0.001 mass % or less, or less than 0.0001 mass % of these components in total if the polishing composition contains these components), a case where the polishing composition is substantially free of polyvinyl alcohol (PVA), polyacrylic acid, and polyacrylamide (that is, it means that the polishing composition does not contain either polyvinyl alcohol (PVA), polyacrylic acid, or polyacrylamide at all (detection limit or less) or contains 0.1 mass % or less, 0.01 mass % or less, 0.001 mass % or less, or less than 0.0001 mass % of these components in total if the polishing composition contains these components), and the like. The concept of “substantially free of at least one kind selected from the group consisting of these” in the present specification is to be understood as such by those substantially in the art.

The surfactant is a substance having a hydrophilic group and a hydrophobic group. Examples of the surfactant include alkyl ether type surfactants such as polyoxyethylene lauryl ether and polyoxyethylene oleyl ether; alkylphenyl ether type surfactants such as polyoxyethylene octylphenyl ether; alkyl ester type surfactants such as polyoxyethylene laurate; alkylamine type surfactants such as polyoxyethylene laurylamino ether; alkylamide type surfactants such as polyoxyethylene lauric acid amide; polypropylene glycol ether type surfactants such as polyoxyethylene polyoxypropylene ether; alkanolamide type surfactants such as oleic acid diethanolamide; allyl phenyl ether type surfactants such as polyoxyalkylene allyl phenyl ether; and the like. Other examples thereof include nonionic surfactants such as propylene glycol, diethylene glycol, monoethanolamine, alcohol ethoxylate, alkylphenol ethoxylate, tertiary acetylene glycol, and alkanolamide, anionic surfactants such as carboxylic acid types such as sodium myristate, sodium palmitate, sodium stearate, sodium laurate, and potassium laurate; sulfuric acid ester types such as sodium octyl sulfate; phosphoric acid ester types such as lauryl phosphoric acid and sodium lauryl phosphate; and sulfonic acid types such as sodium dioctyl sulfosuccinate and sodium dodecylbenzene sulfonate, cationic surfactants such as amines such as laurylamine hydrochloride, and amphoteric surfactants such as lecithin, alkylamine oxide, alkyl betaines such as N-alkyl-N, N-dimethyl ammonium betaine, and sulfobetaines. According to an embodiment of the present invention, the polishing composition is substantially free of at least one kind selected from the group consisting of these.

The oxidizing agent may be a substance having an oxidation-reduction potential higher than an oxidation-reduction potential of a substrate material (particularly, polysilicon) at a pH at which polishing is performed. The pH at which polishing is performed is usually the same as the pH of the polishing composition. As the oxidation-reduction potential of the substrate material, a value, which is obtained by dispersing a powder of the material (particularly, polysilicon) in water to form a slurry, adjusting the slurry to have the same pH as that of the polishing composition, and then measuring the oxidation-reduction potential (oxidation-reduction potential with respect to a standard hydrogen electrode at a liquid temperature of 25° C.) of the slurry using a commercially available oxidation-reduction potential meter, can be adopted. Examples of the oxidizing agent include hydrogen peroxide, a metal oxide, a peroxide, a nitrate, an iodate, a periodate, a hypochlorite, a chlorite, a chlorate, a perchlorate, a persulfate, a dichromate, a permanganate, an organic oxidizing agent, ozone water, a silver (II) salt, an iron (III) salt, and the like. According to an embodiment of the present invention, the polishing composition is substantially free of at least one kind selected from the group consisting of these.

Examples of the compound having a nitrogen atom include salts of such as tetramethylammonium, tetraethylammonium, and tetrabutylammonium, and the like; and the like. Examples of types of the salts include hydroxide, chloride, carbonate, sulfate, and phosphate, and the like. Specific examples thereof include quaternary ammonium compounds such as tetraalkylammonium salts such as tetraalkylammonium hydroxides such as tetramethylammonium hydroxide, tetraethylammonium hydroxide, and tetrabutylammonium hydroxide; tetramethylammonium carbonate; and tetramethylammonium chloride. Examples of the compound having a nitrogen atom include amines such as methylamine, dimethylamine, trimethylamine, ethylamine, diethylamine, triethylamine, ethylenediamine, monoethanolamine, N-(β-aminoethyl) ethanolamine, hexamethylenediamine, diethylenetriamine, triethylenetetramine, anhydrous piperazine, piperazine hexahydrate, 1-(2-aminoethyl) piperazine, N-methylpiperazine, and guanidine; and ammonia. According to an embodiment of the present invention, the polishing composition is substantially free of at least one kind selected from the group consisting of these. According to an embodiment of the present invention, the content (mass %) of the compound having a nitrogen atom represented by the following formula: N(R¹)(R²)(R³)(R⁴), wherein R¹ to R⁴ each independently represent an alkyl group, and the alkyl group may be substituted with an alkyl group, an aryl group, or a hydroxy group, in the polishing composition is less than 0.005 mass %, 0.001 mass % or less, 0.0005 mass % or less, 0.0001 mass % or less, or the detection limit or less.

According to an embodiment of the present invention, the polishing composition does not contain a polymer compound containing a lactam ring, or contains less than 0.0001 mass % of the polymer compound containing a lactam ring if the polishing composition contains the polymer compound containing a lactam ring.

According to an embodiment of the present invention, the polishing composition is substantially free of abrasive grains other than colloidal silica.

According to an embodiment of the present invention, the polishing composition is substantially free of silica having an acidic group derived from an organic acid (for example, a sulfo group, a carboxyl group, a phosphate group, and the like) immobilized on the surface thereof.

According to an embodiment of the present invention, the polishing composition is substantially free of silica having an amino group immobilized on the surface thereof.

According to an embodiment of the present invention, the polishing composition is substantially free of an organic acid.

According to an embodiment of the present invention, the polishing composition is substantially free of a phosphate ester. In the present specification, the phrase “substantially free of a phosphate ester” means that the polishing composition does not contain a phosphate ester at all (detection limit or less), and the phosphate ester may be contained in an amount of less than 0.001 mass % in the polishing composition.

In an embodiment of the present invention, there is provided a polishing composition consisting essentially of colloidal silica having the number of silanol groups of 6/nm² or more and 22/nm² or less, an alkali metal salt, and water, a pH of the polishing composition being 9.0 to 11.5. The above description can be applied to the description of colloidal silica, an alkali metal salt (particularly, potassium hydroxide), water, pH, and an antiseptic agent. In the embodiment, the phrase “consisting essentially of” means that when the polishing composition contains a component (components) other than colloidal silica, an alkali metal salt (particularly, potassium hydroxide), water, and an antiseptic agent, which is optionally contained, the ratio of the component (the total ratio of these components) is 0.1 mass % or less, 0.01 mass % or less, 0.001 mass % or less, or less than 0.0001 mass % in the polishing composition.

According to an embodiment of the present invention, the polishing composition is substantially free of at least one selected from the group consisting of R¹R²R³R⁴N⁺X⁻, R¹R²R³R⁴P⁺X⁻, R¹R²R³S⁺X⁻, an imidazolium salt, and a pyridinium salt, wherein R¹, R², R³, and R⁴ are each independently C₁-C₆ alkyl, C₇-C₁₂ arylalkyl, or C₆-C₁₀ aryl, and X⁻ is an anion.

According to an embodiment of the present invention, the polishing composition is substantially free of at least one selected from the group consisting of hydroxyalkyl cellulose, carrageenan, and xanthan gum.

In an embodiment of the present invention, the polishing composition may be a one-pack type or a multi-pack type including a two-pack type. The polishing composition of an aspect of the present invention may be, for example, diluted (typically, diluted with water) and used as a polishing liquid, or may be used as it is as a polishing liquid. That is, the concept of the polishing composition in the technique according to the present invention includes both a polishing composition (working slurry) that is supplied to an object to be polished and used for polishing the object to be polished and a concentrated solution (a stock solution of a working slurry) that is used for polishing after dilution. The concentration rate of the concentrated solution can be, for example, about 2 times to about 100 times on a volume basis.

### <Method for Producing Polishing Composition>

In an embodiment of the present invention, a method for producing a polishing composition includes adjusting the pH to 9.0 to 11.5 by containing colloidal silica, an alkali metal salt (particularly, potassium hydroxide), water, and an antiseptic agent, other components, and the like, which are optionally contained. The above description can be applied to the description of colloidal silica, an alkali metal salt (particularly, potassium hydroxide), water, pH, an antiseptic agent, and other components. The temperature at which respective components are mixed is not particularly limited, and is preferably 10° C. or higher and 40° C. or lower, and heating may be performed in order to increase the rate of dissolution. The mixing time is also not particularly limited as long as the mixture can be uniformly mixed.

### <Polishing Method of Object to be Polished>

In an embodiment of the present invention, as illustrated in FIG. 1, in the object to be polished 10 including a first layer 1 provided with a recess portion (a layer having an oxygen-silicon bond or a nitrogen-silicon bond) and a second layer 2 formed to fill the inside of the recess portion (a layer having a silicon-silicon bond), a polishing method of an object to be polished includes a step of polishing the second layer 2 to expose the first layer 1. In an embodiment of the present invention, a step of further polishing the first layer after the first layer is exposed is included. By further including such a step, a technical effect of completely removing remaining of an object to be polished, which has to be polished, such as polysilicon, is achieved.

In an embodiment of the present invention, as illustrated in FIG. 1, the first layer 1 (a layer having an oxygen-silicon bond or a layer having a nitrogen-silicon bond) is formed on an arbitrary film (for example, a Si substrate) so as to provide a recess portion. The second layer 2 (a film having a silicon-silicon bond) is formed so as to fill the inside of the recess portion, and the second layer 2 is laminated in an excessive amount so as to protrude from the recess portion of the first layer 1, thereby forming the object to be polished 10 including the first layer 1 and the second layer 2. Such an object to be polished 10 is polished by a polishing apparatus capable of supplying the polishing composition of the present invention.

In an embodiment of the present invention, as a polishing apparatus, it is possible to use a general polishing apparatus in which a holder for holding a substrate or the like having an object to be polished and a motor or the like capable of changing the number of revolutions are attached and which has a polishing table to which a polishing pad (polishing cloth) can be attached.

In an embodiment of the present invention, as the polishing pad, a general nonwoven fabric, polyurethane, a porous fluororesin, and the like can be used without particular limitation. The polishing pad is preferably grooved such that a polishing liquid is accumulated.

In an embodiment of the present invention, as for the polishing conditions, for example, the rotation speeds of the polishing table and the carrier are each independently preferably 10 to 500 rpm. The pressure (polishing pressure) applied to the substrate having an object to be polished is preferably 0.5 to 10 psi. The method of supplying the polishing composition to the polishing pad is not particularly limited, and for example, a method of continuously supplying the polishing composition by a pump or the like is adopted. This supply amount is not limited, but it is preferable that the surface of the polishing pad is covered with the polishing composition of the present invention at all times.

s illustrated in FIG. 2, by applying the polishing composition of the present invention, the polished object 10′, which is the object to be polished after polishing, has an ideal polished surface in which remaining of the object to be polished, which has to be polished, is reduced (no remaining) and recesses are also suppressed (not generated).

The present invention includes the following aspects and embodiments.

1. A polishing composition containing colloidal silica, an alkali metal salt, and water, a pH of the polishing composition being 9.0 to 11.5, wherein (i) in an object to be polished including a first layer provided with a recess portion and a second layer formed to fill the inside of the recess portion, the polishing composition is used for a step of polishing the second layer to expose the first layer, the first layer is selected from a layer having an oxygen-silicon bond and a layer having a nitrogen-silicon bond, and the second layer has a silicon-silicon bond, and/or (ii) the number of silanol groups in the colloidal silica is 6/nm² or more and 22/nm² or less.

2. The polishing composition according to 1., wherein a selectivity, which is a polishing removal rate of the second layer with respect to a polishing removal rate of the first layer (a polishing removal rate of the second layer/a polishing removal rate of the first layer), is 17 to 40.

3. The polishing composition according to 1, or 2., wherein a pulsed NMR specific surface area of the colloidal silica is 40 m²/g or less.

4. The polishing composition according to any one of 1. to 3., wherein an average primary particle size of the colloidal silica is more than 70 nm and less than 100 nm.

5. The polishing composition according to any one of 1. to 4., wherein the alkali metal salt is an alkali metal hydroxide.

6. The polishing composition according to 5., wherein the alkali metal hydroxide is potassium hydroxide.

7. The polishing composition according to any one of 1. to 6., which is substantially free of at least one selected from the group consisting of HEC, PAA, POE lauryl ether, DBS, H₂O₂, ammonia, and amine.

8. The polishing composition according to any one of 1. to 7., which is substantially free of at least one selected from the group consisting of a water-soluble polymer, a surfactant, an oxidizing agent, and a compound having a nitrogen atom.

9. The polishing composition according to any one of 1. to 7., wherein a transmittance when light whose wavelength is 450 nm is transmitted is more than 0.1% and less than 1% in a case where a concentration of the colloidal silica is 1.5 mass %.

10. A polishing composition consisting essentially of colloidal silica having the number of silanol groups of 6/nm² or more and 22/nm² or less, an alkali metal salt, and water, a pH of the polishing composition being 9.0 to 11.5.

11. A polishing composition consisting essentially of colloidal silica having the number of silanol groups of 6/nm² or more and 22/nm² or less, an alkali metal salt, an antiseptic agent, and water, a pH of the polishing composition being 9.0 to 11.5.

### Examples

The present invention will be described in more detail with the following Examples and Comparative Examples. However, the technical scope of the present invention is not limited only to the following Examples. In the following description, unless otherwise specified, the operation was performed under the conditions of room temperature (25° C.)/relative humidity of 40 to 50% RH.

### <Production of Polishing Composition>

A polishing composition was prepared by mixing abrasive grains, an alkali metal salt, and water so as to have the composition shown in Table 1. For example, a polishing composition of Example 1 contains 1.5 mass % of colloidal silica having a pulsed NMR specific surface area of 23.8 m²/g, the number of silanol groups of 7.9/nm², an average primary particle size of 90 nm, and an average secondary particle size of 220 nm, potassium hydroxide, and water and has a pH of 10.

### <Method of Calculating Particle Size>

The average primary particle size of the abrasive grains was calculated from the specific surface area of the abrasive grains measured by the BET method using “Macsorb HM model-1210” manufactured by MOUNTECH Co., Ltd. and the density of the abrasive grains.

The average secondary particle size of the abrasive grains was measured by a dynamic light scattering particle size and particle size distribution apparatus UPA-UT151 manufactured by NIKKISO CO., LTD.

### <Method of Calculating Number of Silanol Groups>

The number of silanol groups (unit: number/nm²) per unit surface area of the abrasive grains was calculated by the following method after each parameter was measured or calculated by the following measurement method or calculation method.

More specifically, C in the following formula is the total mass of the abrasive grains, and S in the following formula is the BET specific surface area of the abrasive grains. Further specifically, first, 1.50 g of abrasive grains as a solid content is collected in a 200 ml beaker, 100 ml of pure water is added to form a slurry, and then 30 g of sodium chloride is added to dissolve the slurry. Next, 1 N hydrochloric acid is added to adjust the pH of the slurry to 3.0 to 3.5, and then pure water is added until the slurry reaches 150 ml.

For this slurry, the pH is adjusted to 4.0 using 0.1 N sodium hydroxide at 25° C. using an automatic titrator (COM-1700 manufactured by HIRANUMA Co., Ltd.), and the volume V [L] of the 0.1 N sodium hydroxide solution required to increase the pH from 4.0 to 9.0 is measured by pH titration. The average silanol group density (the number of silanol groups) can be calculated by the following formula.

$$ρ = ( c \times V \times {N}_{A} ) / ( C \times S )$$

In the above formula,
ρ represents an average silanol group density (number of silanol groups) (number/nm²);
c represents a concentration (mol/L) of the sodium hydroxide solution used for titration;
V represents a volume (L) of the sodium hydroxide solution required to increase the pH from 4.0 to 9.0;
N_{A} represents the Avogadro constant (number/mol);
C represents a total mass (solid content) (g) of the abrasive grains; and
S represents a weighted average value (nm²/g) of the BET specific surface area of the abrasive grains. The BET specific surface area is a value of the specific surface area of the abrasive grains measured by the BET method using “Macsorb HM model-1210” manufactured by MOUNTECH Co., Ltd.

### <Method of Measuring Pulsed NMR Specific Surface Area>

A dispersion in which each abrasive grain (raw material colloidal silica) was dispersed in water so as to have a concentration of 20 mass % was prepared as a sample. Table 1 shows the results of measuring the specific surface area under the following measurement conditions using a pulsed NMR particle interface characteristic evaluator (manufactured by Xigo nanotools).

### Measurement Conditions

Bulk relaxation time: 2409 ms

Specific surface relaxivity: 0.00026

Volume ratio of particle to liquid: 0.1136.

### <Measurement of pH of Polishing Composition>

A value obtained by performing three-point calibration using a glass electrode type hydrogen n ion concentration indicator (Model: F-23 manufactured by HORIBA, Ltd.), and a standard buffer solutions (a phthalate pH buffer solution at pH: 4.01 (25° C.), a neutral phosphate pH buffer solution at pH: 6.86 (25° C.), and a carbonate pH buffer solution at pH: 10.01 (25° C.)), placing a glass electrode in the polishing composition, and then obtaining a stabilized value after 2 minutes or longer was measured as the pH of the polishing composition.

### <Measurement of Transmittance of Polishing Composition>

The transmittance of the polishing composition was measured by irradiating the polishing composition with light whose wavelength is 450 nm using an ultraviolet-visible spectrophotometer (UV-2450 manufactured by SHIMADZU CORPORATION). The results thereof were shown in Table 1.

### <Measurement of Polishing Removal Rate>

The surface of the object to be polished was polished using the polishing composition under the following polishing conditions. As the object to be polished, a silicon wafer (300 mm, blanket wafer) having a polysilicon (Poly-Si) film with a thickness of 5000 Å formed on a surface thereof and a silicon wafer (300 mm, blanket wafer) having a P-TEOS film (a TEOS film (silicon dioxide film) formed by plasma CVD) with a thickness of 10000 Å formed on a surface thereof were respectively used.

### (Polishing Conditions)

Polishing apparatus: CMP single-side polishing apparatus FREX300E for 300 mm manufactured by EBARA CORPORATION

Pad: Hard polyurethane pad IC1010 manufactured by Nitta Haas Incorporated

Polishing pressure: 2.2 psi (1 psi=6894.76 Pa, the same applies hereinafter)

Number of revolutions of polishing table: 70 rpm

Number of revolutions of carrier: 70 rpm

Supply of polishing composition: flow-through

Supply amount of polishing composition: 200 ml/min

Polishing time: 60 seconds

The polishing removal rate was measured by determining the thickness with an optical film thickness measuring instrument (ASET-f5x: manufactured by KLA-Tencor Corporation) and dividing (thickness before polishing)-(thickness after polishing) by the polishing time. The ratio of the polishing removal rate (Å/min) of the polysilicon film with respect to the polishing removal rate (Å/min) of the P-TEOS film was calculated as a selectivity. The results thereof were shown in Table 1.

### <Recess Evaluation of Polysilicon>

The pattern wafer with a polysilicon film was polished using the polishing composition according to the following [Condition 1]. As illustrated in FIG. 1, the pattern wafer was obtained by laminating a P-TEOS film (1000 Å) on a Si substrate, forming a recess portion by digging a trench having a depth of 1000 Å, and then laminating a polysilicon film (2000 Å) so as to fill the recess portion.

The polishing of the pattern wafer with a polysilicon film was terminated after further continuation by a time corresponding to 40% of the polishing time until the end point signal was detected after the end point signal was detected. In this way, a step of further polishing the first layer (P-TEOS film) after the first layer ((P-TEOS film) is exposed was realized.

In the isolated wiring portion having a width of 1 μm on the surface of the pattern wafer, the recess amount was measured using an atomic force microscope (trade name: WA-1300, manufactured by Hitachi Kenki Fine Tech Co., Ltd.). The recess amount thus obtained was evaluated according to the following criteria.

### [Condition 1]

Polishing apparatus: CMP single-side polishing apparatus FREX300E for 300 mm manufactured by EBARA CORPORATION

Pad: Hard polyurethane pad IC1010 manufactured by Nitta Haas Incorporated

Polishing pressure: 2.2 psi (1 psi=6894.76 Pa, the same applies hereinafter)

Number of revolutions of polishing table: 70 rpm

Number of revolutions of carrier: 70 rpm

Supply of polishing composition: flow-through

Supply amount of polishing composition: 200 ml/min

### [Recess Amount]

The recess was determined according to the following four-stage criteria. A and x are practically unacceptable. The results thereof were shown in Table 1.

⊙: less than 15 nm

∘: 15 nm or more and less than 30 nm

Δ: 30 nm or more and less than 50 nm

x: 50 nm or more

### <Residual Polysilicon (Polishing Residue)>

The film thickness of polysilicon remaining on the polished P-TEOS film was measured using an optical film thickness measuring instrument (ASET-f5x: manufactured by KLA-Tencor Corporation). The film thickness at this time was defined as a polishing residue, and was determined according to the following four-stage criteria. 4 and x are practically unacceptable. The results thereof were shown in Table 1.

⊙: less than 5 Å

∘: 5 Å or more and less than 10 Å

Δ: 10 Å or more and less than 20 Å

x: 20 Å or more

### [Metal Impurity Measurement]

The polished silicon wafer with a P-TEOS film was cleaned for 60 seconds using a PVA brush in a cleaning unit while being splashed with deionized water (DIW). Thereafter, drying was performed with a spin dryer for 30 seconds. The concentrations of Na, K, and Li on the wafer surface after cleaning were measured using a total reflection fluorescent X-ray apparatus (apparatus name; TREX-610T). The results thereof were shown in Table 1.

TABLE 1

| | Abrasive grains (colloidal silica) | | | | | | | | |
|---|---|---|---|---|---|---|---|---|---|
| | | Pulsed | | | | | | Evaluation item | |
| | | NMR | Number of | Average | | | | Poly- | P-TEOS |
| | | specific | silanol | primary | | | | silicon | polishing |
| | Amount | surface | groups | particle | Alkali | | Trans- | polishing | removal |
| | added | area | [number/ | size | metal | | mittance | removal rate | rate |
| | [mass %] | [m²/g] | nm²] | [nm] | salt | pH | (%) | [Å/min] | [Å/min] |
| Example 1 | 1.5 | 23.8 | 7.9 | 90 | KOH | 10 | 0.20 | 3059 | 93 |
| Example 2 | 1.5 | 31.9 | 6.6 | 70 | KOH | 10 | 0.80 | 2810 | 101 |
| Example 3 | 1.5 | 23.8 | 7.9 | 90 | NaOH | 10 | 0.20 | 3003 | 90 |
| Example 4 | 1.5 | 23.8 | 7.9 | 90 | K₂CO₃ | 10 | 0.20 | 3046 | 178 |
| Example 5 | 1.5 | 26.1 | 17.5 | 100 | KOH | 10 | 0.15 | 2799 | 89 |
| Example 6 | 1.5 | 23.8 | 7.9 | 90 | KOH | 9.5 | 0.15 | 2353 | 75 |
| Example 7 | 1.5 | 23.8 | 7.9 | 90 | KOH | 11 | 0.25 | 3324 | 113 |
| Example 8 | 1.5 | 23.8 | 7.9 | 90 | LiOH | 10 | 0.20 | 2996 | 93 |
| Comparative Example 1 | 1.5 | 65.7 | 5.5 | 30 | KOH | 10 | 50 | 2298 | 63 |
| Comparative Example 2 | 1.5 | 20.1 | 1.5 | 60 | KOH | 10 | 0.33 | 1835 | 124 |
| Comparative Example 3 | 1.5 | 70.5 | 3.1 | 12 | KOH | 10 | 95 | 513 | 12 |
| Comparative Example 4 | 1.5 | 48.7 | 3.7 | 25 | KOH | 10 | 60 | 1252 | 42 |
| Comparative Example 5 | 1.5 | 29.9 | 3.4 | 35 | KOH | 10 | 60 | 1138 | 73 |
| Comparative Example 6 | 1.5 | 35.2 | 1.6 | 30 | KOH | 10 | 50 | 1971 | 53 |
| Comparative Example 7 | 1.5 | 36.6 | 5.9 | 55 | KOH | 10 | 1.10 | 2113 | 58 |
| Comparative Example 8 | 1.5 | 21.9 | 23.8 | 220 | KOH | 10 | 0.03 | 2225 | 47 |
| Comparative Example 9 | 1.5 | 23.8 | 7.9 | 90 | KOH | 7.5 | 0.13 | 653 | 38 |
| Comparative Example 10 | 1.5 | 23.8 | 2.5 | 90 | KOH | 10 | 0.20 | 2923 | 31 |
| Comparative Exemple 11 | 1.5 | 23.8 | 7.9 | 90 | KOH | 11.7 | 0.23 | 3529 | 119 |

| | Evaluation item | | | | | |
|---|---|---|---|---|---|---|
| | | | | Number of atoms | | |
| | | | | after washing | | |
| | Poly- | | Residual | (×10¹⁰ | | |
| | silicon/ | Recess | poly- | atoms/cm²) | | |
| | TEOS | [Å] | silicon | Na | K | Li |
| Example 1 | 33 | ⊚ | ⊚ | 0.02 | 17 | 0 |
| Example 2 | 28 | ⊚ | ◯ | 0.03 | 19 | 0 |
| Example 3 | 33 | ⊚ | ⊚ | 35 | 0.03 | 0 |
| Example 4 | 17 | ◯ | ⊚ | 0.03 | 18 | 0 |
| Example 5 | 31 | ⊚ | ◯ | 0.02 | 21 | 0 |
| Example 6 | 31 | ◯ | ◯ | 0.03 | 15 | 0 |
| Example 7 | 29 | ◯ | ⊚ | 0.03 | 16 | 0 |
| Example 8 | 32 | ⊚ | ⊚ | 0 | 0 | 38 |
| Comparative Example 1 | 36 | Δ | Δ | 0.03 | 18 | 0 |
| Comparative Example 2 | 15 | ⊚ | Δ | 0.02 | 15 | 0 |
| Comparative Example 3 | 43 | X | X | 0.03 | 15 | 0 |
| Comparative Example 4 | 30 | X | X | 0.02 | 16 | 0 |
| Comparative Example 5 | 16 | ⊚ | X | 0.03 | 19 | 0 |
| Comparative Example 6 | 37 | Δ | X | 0.03 | 18 | 0 |
| Comparative Example 7 | 36 | ⊚ | Δ | 0.02 | 20 | 0 |
| Comparative Example 8 | 47 | Δ | Δ | 0.03 | 21 | 0 |
| Comparative Example 9 | 17 | Δ | Δ | 0.03 | 18 | 0 |
| Comparative Example 10 | 94 | Δ | X | 0.02 | 16 | 0 |
| Comparative Exemple 11 | 30 | X | ⊚ | 0.03 | 20 | 0 |

### DISCUSSION

In the polishing compositions of Examples, remaining of polysilicon, which has to be polished, could be reduced, and recesses could also be suppressed. On the other hand, in the polishing compositions of Comparative Examples, as illustrated in FIGS. 3 to 5, remaining of polysilicon, which has to be polished, was generated or recesses were promoted.

The polishing composition of Example 1 had the best results among all Examples.

When polishing was performed with the polishing compositions of Examples 2 and 5, the remaining film of polysilicon was slightly thick or a slight recess was generated. From these results, it is found that the number of silanol groups in the abrasive grains (colloidal silica) is preferably more than 6.6/nm² and less than 17.5/nm². It is found that the average primary particle size of the abrasive grains (colloidal silica) is preferably more than 70 nm and less than 100 nm.

When polishing was performed with the polishing composition of Example 3, remaining of sodium as a metal impurity was slightly large. When polishing was performed with the polishing composition of Example 4, the selectivity was slightly small, and recesses were also slightly generated. When polishing was performed with the polishing composition of Example 8, remaining of lithium as a metal impurity was slightly large. From these results, it is suggested that potassium hydroxide is preferable as the alkali metal salt.

When polishing was performed with the polishing composition of Example 6, the remaining film of polysilicon was slightly thick, and recesses were slightly generated. When polishing was performed with the polishing composition of Example 7, recesses were slightly generated. From these results, it is suggested that the pH of the polishing composition is preferably more than 9.5 and less than 11.

### REFERENCE SIGNS LIST

1 First layer
2 Second layer
2a Recess
2b Remaining of second layer which has to be polished
10 Object to be polished
10′ Polished object

The present application is based on Japanese Patent Application No. 2023-166812 filed on Sep. 28, 2023, the disclosure content of which is incorporated herein by reference in its entirety.

What is claimed is:

1. A polishing composition comprising colloidal silica, an alkali metal salt, and water, a pH of the polishing composition being 9.0 to 11.5, wherein
(i) in an object to be polished including a first layer provided with a recess portion and a second layer formed to fill the inside of the recess portion, the polishing composition is used for a step of polishing the second layer to expose the first layer, the first layer is selected from a layer having an oxygen-silicon bond and a layer having a nitrogen-silicon bond, and the second layer has a silicon-silicon bond, and/or
(ii) the number of silanol groups in the colloidal silica is 6/nm² or more and 22/nm² or less.

2. The polishing composition according to claim 1, wherein a selectivity, which is a polishing removal rate of the second layer with respect to a polishing removal rate of the first layer, is 17 to 40.

3. The polishing composition according to claim 1, wherein a pulsed NMR specific surface area of the colloidal silica is 40 m²/g or less.

4. The polishing composition according to claim 1, wherein an average primary particle size of the colloidal silica is more than 70 nm and less than 100 nm.

5. The polishing composition according to claim 1, wherein the alkali metal salt is an alkali metal hydroxide.

6. The polishing composition according to claim 5, wherein the alkali metal hydroxide is potassium hydroxide.

7. The polishing composition according to claim 1, which is substantially free of at least one selected from the group consisting of HEC, PAA, POE lauryl ether, DBS, H₂O₂, ammonia, and amine.

8. The polishing composition according to claim 1, which is substantially free of at least one selected from the group consisting of a water-soluble polymer, a surfactant, an oxidizing agent, and a compound having a nitrogen atom.

9. The polishing composition according to claim 1, wherein a transmittance when light whose wavelength is 450 nm is transmitted is more than 0.1% and less than 1% in a case where a concentration of the colloidal silica is 1.5 mass %.

10. A polishing composition consisting essentially of colloidal silica having the number of silanol groups of 6/nm² or more and 22/nm² or less, an alkali metal salt, and water, a pH of the polishing composition being 9.0 to 11.5.

11. A polishing composition consisting of essentially colloidal silica having the number of silanol groups of 6/nm² or more and 22/nm² or less, an alkali metal salt, an antiseptic agent, and water, a pH of the polishing composition being 9.0 to 11.5.
